(19) United States
(12) Patent Application Publication
(10) Pub. No.: US 2024/0395068 A1
(43) Pub. Date: Nov. 28, 2024

(54) IMAGE PROCESSING METHOD FOR HUMAN BODY POSTURE TRANSFORMATION, ELECTRONIC DEVICE FOR THE SAME, TERMINAL DEVICE IN COMMUNICATION CONNECTION WITH THE ELECTRONIC DEVICE, AND NON-TRANSIENT COMPUTER-READABLE RECORDING MEDIUM

(71) Applicant: COMPAL ELECTRONICS, INC., Taipei (TW)

(72) Inventors: CHUAN-SUNG CHANG, Taipei (TW); PIN-YU CHOU, Taipei (TW); HUI-MEI HUNG, Taipei (TW); CHING-JUI HSIAO, Taipei (TW); YUEH-HUA LEE, Taipei (TW); CARLOS EDUARDO NOGUEIRA, Taipei (TW); ALEXANDRE RIBEIRO LOPES, Taipei (TW); FERNANDO PEREIRA DOS SANTOS, Taipei (TW)

(21) Appl. No.: 18/619,221

(22) Filed: Mar. 28, 2024

Related U.S. Application Data
(60) Provisional application No. 63/468,272, filed on May 23, 2023.

(51) Int. Cl. G06V 40/20; G06V 40/16

(52) U.S. Cl. CPC G06V 40/20; G06V 40/16

(57) ABSTRACT

An image processing method for human body posture transformation, which is executed by an electronic device reading an executable code to identify a preset object using artificial intelligence, and performing image processing to capture target postures of the preset object. The method includes the steps of identifying an object, detecting postures, and capturing target postures. The steps involve detecting the preset object undergoing transformation between different postures within a target duration. A capture requirement is met when each posture is visible for a posture visibleness duration and reaches a duration threshold. A target posture transformation video which lasts for a segment duration is captured from an initial image and uploaded to the cloud for storage. An electronic device for human body posture transformation image processing, a terminal device in communication connection with the electronic device, and a non-transient computer-readable recording medium are further provided.

### CROSS-REFERENCE TO RELATED APPLICATION

This non-provisional application claims priority under 35 U.S.C. § 119 (e) on US provisional Patent Application No. 63/468,272 filed on May 23, 2023, the entire contents of which are hereby incorporated by reference.

### BACKGROUND OF THE INVENTION

### 1. Field of the Invention

The present disclosure relates to image processing, and in particular to an image processing method for human body posture transformation, an electronic device for initial image processing, a terminal device in communication connection with the electronic device, and a non-transient computer-readable recording medium.

### 2. Description of the Related Art

Body growth in infancy consists of stages of learning to roll over, learning to sit, learning to crawl, learning to stand, and learning to walk. Parents consider each infant body growth stage precious and want to capture the precious moments with their babies through photos or videos to repeatedly view whenever recalling the precious moments.

Conventional video surveillance systems analyze, process, and automatically capture, using artificial intelligence (AI), images captured by cameras. However, when it comes to image selection and capture, AI focuses on specific facial expressions or postures instead of dynamic movements of limbs (arms, hands, legs, feet). As a result, the movements of the limbs of babies learning to roll over, learning to sit, learning to crawl, learning to stand, and learning to walk cannot be precisely identified and visually recorded by conventional video surveillance systems but have to be manually selected to the detriment of the time efficiency of processing precious images.

### BRIEF SUMMARY OF THE INVENTION

It is an objective of the present disclosure to provide an image processing method for human body posture transformation, an electronic device for initial image processing, a terminal device in communication connection with the electronic device, and a non-transient computer-readable recording medium and thus enable the detection and identification of continuous, dynamic variations in limb posture in the course of specific human body movements, allowing images of precious moments to be automatically and accurately captured to meet user expectations.

To achieve the above and other objectives, the disclosure provides an image processing method for human body posture transformation, the method being executed by an electronic device reading an executable code to identify an object, for example, a preset object using artificial intelligence, and performing image processing to capture target postures of the preset object. The method comprises the steps of identifying an object, detecting postures, and capturing target postures. The step of identifying an object involves identifying the preset object in an initial image via artificial intelligence, and detecting the preset object being visible in the initial image for a target duration within a segment duration. The step of detecting postures involves detecting, utilizing artificial intelligence, the preset object's body transforming from a first posture to a second posture, wherein the first posture and the second posture are two different postures comprising, for example, lying supine, lateral recumbent, lying prone, sitting, crawling, standing, and embracing, the first posture lasts for a first posture duration within the target duration, and the second posture lasts for a second posture duration within the target duration. The step of capturing target postures involves capturing from the initial image a target posture transformation video that lasts for the segment duration and uploading the target posture transformation video to the cloud for storage when a capture requirement is met, wherein the capture requirement is met when the first posture duration and the second posture duration each reach a duration threshold within the target duration.

In an embodiment of the present disclosure, a step of detecting a human face precedes the step of the capturing target postures and entails detecting a human face being visible for a facial visibility duration within the target duration utilizing artificial intelligence, and the capture requirement further includes the facial visibility duration reaching a duration threshold.

In an embodiment of the present disclosure, within the segment duration, the first posture precedes the second posture.

In an embodiment of the present disclosure, a time order for the first posture and the second posture within the segment duration is from lying supine, lateral recumbent, lying prone, sitting, crawling, standing to embracing, or from lying prone, lateral recumbent, lying supine, sitting, crawling, standing to embracing.

In an embodiment of the present disclosure, the preset object is defined as a baby, the second posture is defined as standing, and the image processing method further comprises defining a body frame of the standing preset object, calculating a body width of the preset object according to the body frame, defining a center of the body frame, and detecting the standing preset object's movement and calculating a movement distance of the center after the preset object's body has transformed from the first posture to the second posture within the target duration in the step of the detecting postures, wherein in the step of the capturing target postures the capture requirement further includes the movement distance being greater than the body width.

In an embodiment of the present disclosure, the preset object is defined as a baby, the first posture and the second posture are lying supine and lying prone respectively, the step of detecting postures further comprises detecting an intermediate posture while the preset object's body is transforming from the first posture to the second posture within the segment duration, and in the step of capturing target postures, the capture requirement further includes the intermediate posture being lateral recumbent, the intermediate posture being visible for a third posture duration within the target duration, and the third posture duration reaching a duration threshold.

In an embodiment of the present disclosure, another object other than the preset object can be identified in the step of the identifying an object, the preset object's face and/or the another object's face are/is detected in the step of detecting a human face, and, in the step of detecting postures, the preset object has the first posture being one of lying supine, lateral recumbent, lying prone, sitting, crawling and standing and the second posture being embracing, with the preset object begging the another object for an embrace on-site, or the preset object has the first posture being crawling or standing and the second posture being embracing, with the preset object taking the initiative to approach the another object to beg for an embrace.

In an embodiment of the present disclosure, the first posture duration, the second posture duration, and the facial visibility duration within the segment duration are each either continuous or intermittent and thus cumulative.

In an embodiment of the present disclosure, the step of detecting postures further comprises defining a body frame of the preset object and identifying a first confidence score for visibility of the first posture or the second posture, and the step of detecting a human face further comprises defining a face frame of the preset object and identifying a second confidence score for visibility of the face.

The present disclosure further provides a non-transient computer-readable recording medium applicable to the method detailed above.

The present disclosure further provides an electronic device for initial image processing, comprising a camera unit for taking an initial image; and an intelligent processing unit electrically connected to the camera unit to receive the initial image. The intelligent processing unit comprises a target detection module for identifying a preset object in the initial image via artificial intelligence and detecting the preset object being visible in the initial image for a target duration within a segment duration; a posture identification module electrically connected to the target detection module to detect, via artificial intelligence, the preset object's body transforming from a first posture to a second posture. The first posture and the second posture are two different postures of lying supine, lateral recumbent, lying prone, sitting, crawling, standing, and embracing. The first posture lasts for a first posture duration within the target duration, and the second posture lasts for a second posture duration within the target duration. A target posture capturing module is electrically connected to the target detection module and the posture identification module. The target posture capturing module sets a duration threshold for each of the target durations, the first posture duration, and the second posture duration. A capture requirement is met when the first posture duration and the second posture duration reach the duration thresholds respectively, causing the target posture capturing module to capture, from the initial image, a target posture transformation video that lasts for the segment duration and uploads the target posture transformation video to the cloud for storage.

In an embodiment, the camera unit and the intelligent processing unit are each a physical host.

In an embodiment, the intelligent processing unit further comprises a human face identification module adapted to detect, using artificial intelligence, a human face being visible for a facial visibility duration within the target duration. The target posture capturing module sets a duration threshold for the facial visibility duration, and the capture requirement further includes the facial visibility duration reaching the duration threshold.

The present disclosure further provides a terminal device in communication connection with the electronic device, wherein the terminal device comes with an app, executes the app to connect to the cloud, and downloads the target posture transformation video for playing.

Therefore, when a capture requirement is met, an image processing method for human body posture transformation and an electronic device, as provided by the present disclosure, are effective in automatically capturing a target posture transformation video that lasts for a segment duration and uploading the target posture transformation video to the cloud for storage and for subsequent download therefrom through a terminal device for playing so as to meet user expectations. The capture requirement is met upon detection with the image processing method and electronic device that the preset object's body transforms from a posture to another posture. The two postures are selected from two different postures of lying supine, lateral recumbent, lying prone, sitting, crawling, standing and embracing, and each posture is visible for a posture duration which reaches a duration threshold.

### BRIEF DESCRIPTION OF THE DRAWINGS

FIG. 1 is a flowchart of the basic process flow of a method according to an embodiment of the present disclosure.

FIG. 2 is a block diagram of an electronic device for performing the method of FIG. 1.

FIG. 3A is a drawing illustrating different postures of a preset object according to an embodiment of the present disclosure.

FIG. 3B is a drawing illustrating different postures of a preset object according to an embodiment of the present disclosure.

FIG. 3C is a drawing illustrating different postures of a preset object according to an embodiment of the present disclosure.

FIG. 3D is a drawing illustrating different postures of a preset object according to an embodiment of the present disclosure.

FIG. 3E is a drawing illustrating different postures of a preset object according to an embodiment of the present disclosure.

FIG. 3F is a drawing illustrating different postures of a preset object according to an embodiment of the present disclosure.

FIG. 3G is a drawing illustrating different postures of a preset object according to an embodiment of the present disclosure.

FIG. 4 is a flowchart of process flow A according to an embodiment of the present disclosure.

FIG. 5 is a flowchart of process flow B according to an embodiment of the present disclosure.

FIG. 6 is a flowchart of process flow C according to an embodiment of the present disclosure.

FIG. 7 is a flowchart of process flow D according to an embodiment of the present disclosure.

FIG. 8 is a block diagram of various situations of posture transformation according to an embodiment of the present disclosure.

FIG. 9 is a schematic view of the time order of an instance of learning to sit according to an embodiment of the present disclosure.

FIG. 10 is a schematic view of the time order of an instance of learning to crawl according to an embodiment of the present disclosure.

FIG. 11 is a schematic view of the time order of an instance of learning to stand according to an embodiment of the present disclosure.

FIG. 12 is a schematic view of distance calculation of an instance of learning to walk according to an embodiment of the present disclosure.

FIG. 13 is a schematic view of the time order of an instance of learning to roll over according to an embodiment of the present disclosure.

FIG. 14 is a schematic view of the time order of an instance of embracing according to an embodiment of the present disclosure.

### DETAILED DESCRIPTION OF THE INVENTION

To facilitate understanding of the objectives, characteristics, and effects of the present disclosure, embodiments together with the attached drawings for the detailed description of the present disclosure are provided.

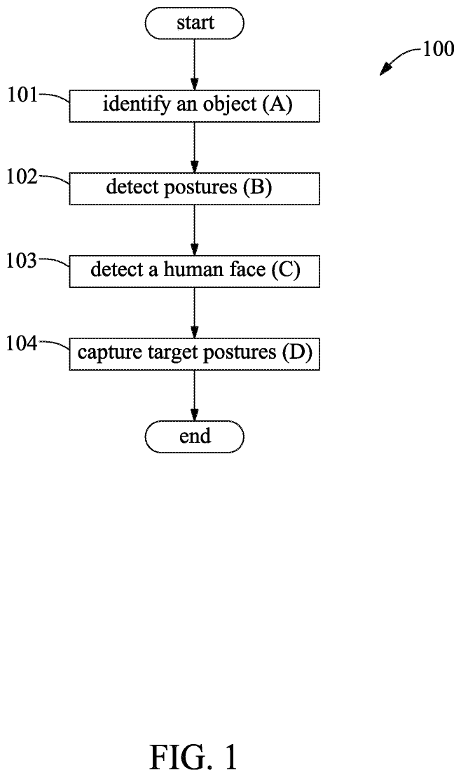

Referring to FIG. 1 through FIG. 14, the present disclosure provides a processing method 100 for human body posture transformation, an electronic device 200, a terminal device 300 connected to the electronic device 200, and a non-transient computer-readable recording medium for storing a plurality of executable codes.

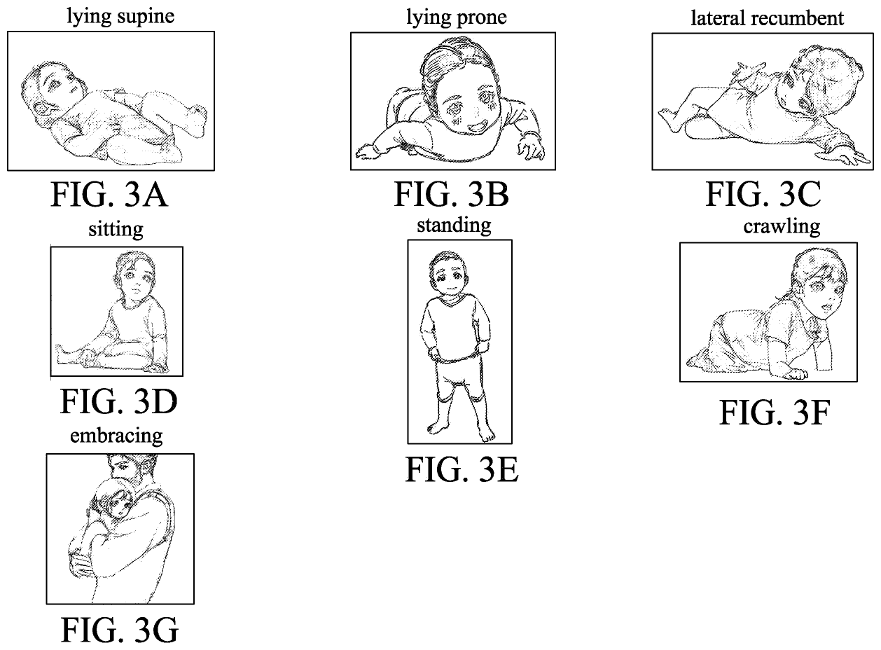

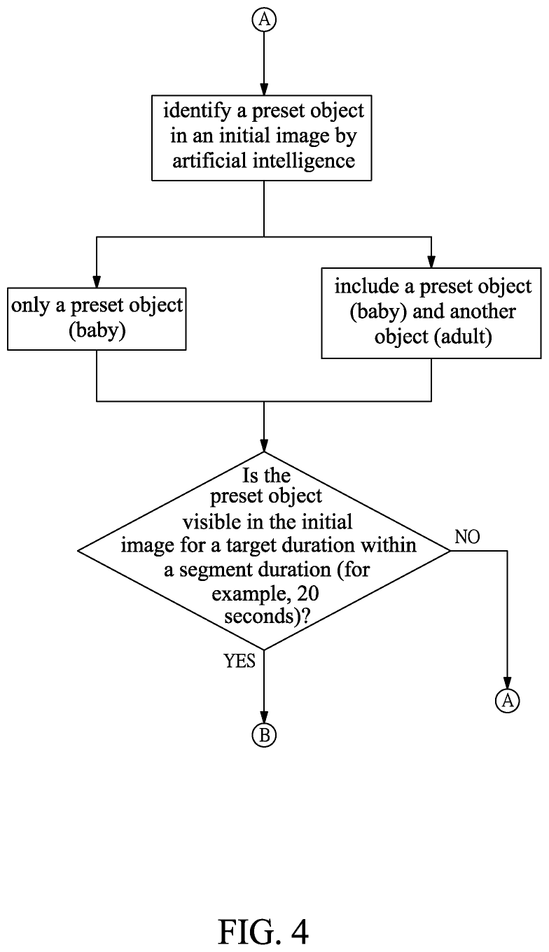

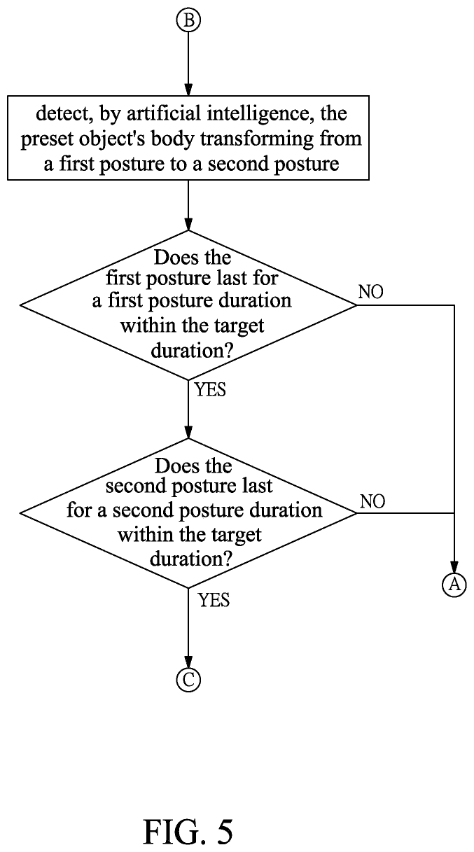

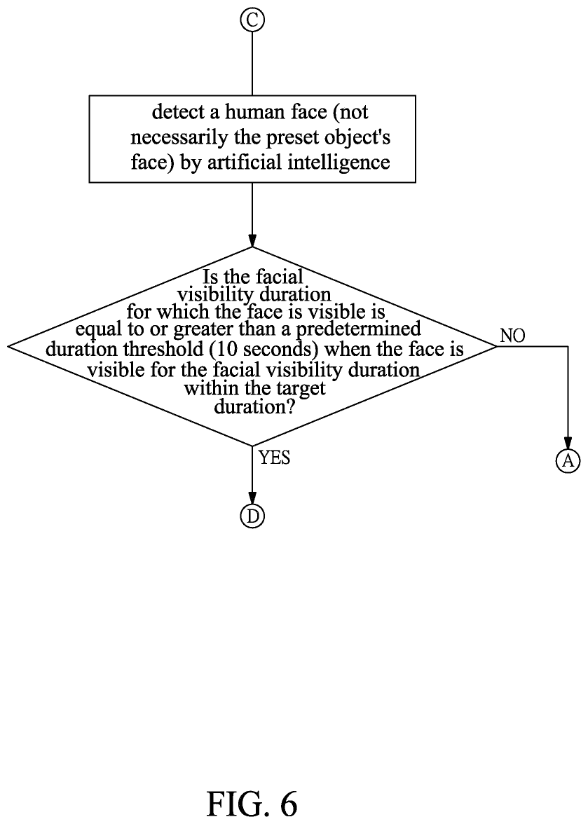

The processing method 100 is executed by the electronic device 200 reading the executable codes to identify a preset object using artificial intelligence, including performing, in the embodiment of FIG. 1, the steps of identifying an object 101 (expressed as process flow A in FIG. 1 to correspond to FIG. 3), detecting postures 102 (expressed as process flow B in FIG. 1 to correspond to FIG. 4), detecting a human face 103 (expressed as process flow C in FIG. 1 to correspond to FIG. 5), and capturing target postures 104 (expressed as process flow D in FIG. 1 to correspond to FIG. 6), thereby performing image processing to capture target postures of the preset object.

A plurality of executable codes executed by the processing method 100 is stored in the non-transient computer-readable recording medium. The electronic device 200 reads the executable codes from the non-transient computer-readable recording medium and then executes the executable codes.

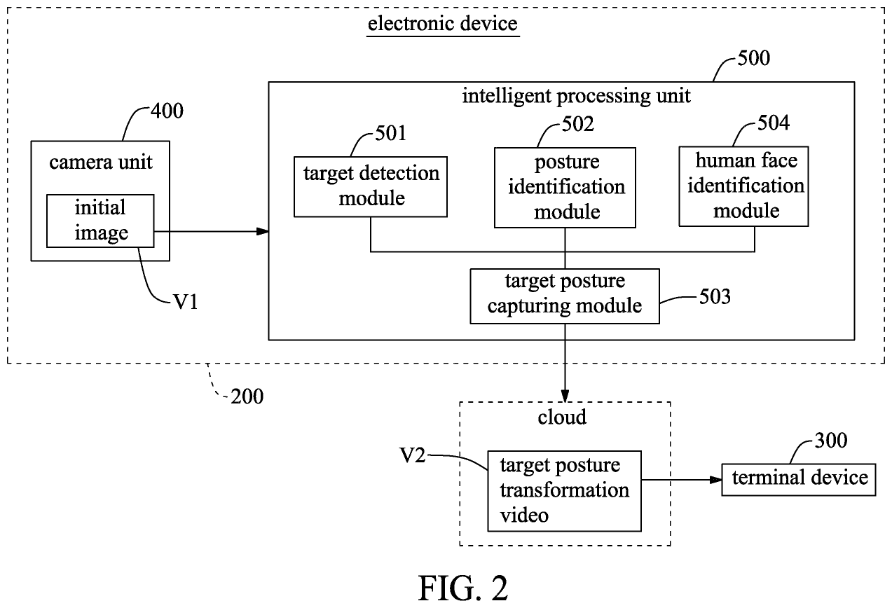

In an embodiment illustrated in FIG. 2, the electronic device 200 for executing the processing method 100 comprises a camera unit 400 and an intelligent processing unit 500. The camera unit 400 is electrically connected to the intelligent processing unit 500. The intelligent processing unit 500 comprises a target detection module 501, a posture identification module 502, and a target posture capturing module 503. The target detection module 501 is adapted to perform the step of identifying an object 101. The posture identification module 502 is adapted to perform the step of detecting postures 102. The target posture capturing module 503 is adapted to perform the step of capturing target postures 104.

In an embodiment, the intelligent processing unit 500 further comprises a human face identification module 504 adapted to perform the step of detecting a human face 103. The human face identification module 504 detects a human face being visible for a facial visibility duration within the target duration via artificial intelligence. The target posture capturing module 503 sets a duration threshold for the facial visibility duration, and the capture requirement further includes the facial visibility duration reaching the duration threshold. The human face identification module 504 and the step of the detecting a human face 103 performed by it are not necessary for the processing method 100 and thus can be dispensed with or are not executed in a variant embodiment.

The electronic device 200 is a physical host. The intelligent processing unit 500 and the camera unit 400 electrically connected to the intelligent processing unit 500 are disposed in the same casing, but the present disclosure is not limited thereto. In a variant embodiment, the electronic device 200 is a cloud host. An initial image V1 is stored in a database (not shown), and the database is a cloud server or a local server. The electronic device 200 is in communication connection with the database. A target posture transformation video V2 is uploaded to the cloud for storage and downloaded therefrom by the electronic device 200 and/or the terminal device 300.

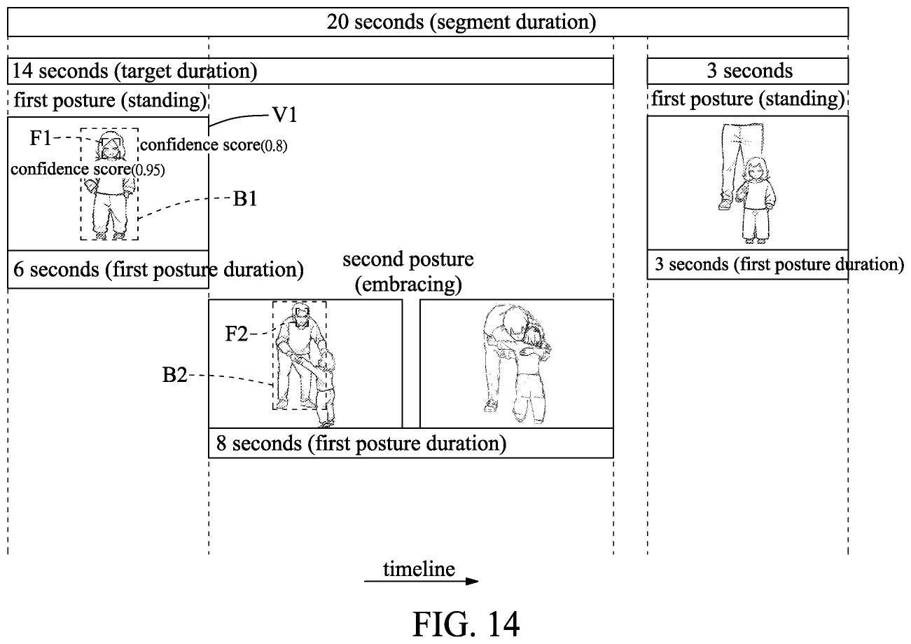

The terminal device 300 is a portable mobile communication device, for example, smartphone, tablet, or laptop, is in communication connection with the electronic device 200 wired or wirelessly via the Internet. The terminal device 300 comes with an app 301 (see FIG. 2, FIG. 14). The terminal device 300 executes the app 301 to connect to the cloud and download the target posture transformation video V2, allowing a user to use the terminal device 300 to watch the target posture transformation video V2.

The processing method 100 is executed by the electronic device 200 to detect that the preset object in the initial image V1 is visible for a target duration within a segment duration, detect, using artificial intelligence, that the preset object's body has transformed from a first posture to a second posture, and thus capture from the initial image V1 a target posture transformation video V2 that lasts for the segment duration. The first posture and the second posture are two different postures of lying supine, lateral recumbent, lying prone, sitting, crawling, standing, and embracing, as shown in FIG. 3. The aforesaid postures shown in FIG. 3 serve as exemplary purposes and are illustrative rather than restrictive of the embodiments of the present disclosure.

Regarding the execution of the processing method 100, the step of the identifying an object 101, as expressed by process flow A shown in FIG. 4, is performed to identify a preset object visible in any one initial image V1 using artificial intelligence and determine whether the preset object is visible for a target duration within a segment duration in the initial image V1. The detection of the preset object involves detecting either just a preset object, say a baby, in the initial image V1 or both a preset object (say a baby) and another object (say an adult, another baby, or an animal like a cat or a dog) in the initial image V1.

In an embodiment, the segment duration is, for example, 20 seconds, and the target duration is, for example, equal to or greater than 15 seconds, such that the processing method 100 proceeds to the step of detecting postures 102 when the preset object is visible for the target duration (15 seconds) within the segment duration (20 seconds). The target duration within the segment duration is either continuous or intermittent and thus cumulative. Referring to FIG. 3, the step of identifying an object 101 involves determining whether the preset object is visible for the target duration within the segment duration of the initial image V1. In this step, when it is determined that the preset object is visible for the target duration of at least 15 seconds within the segment duration of 20 seconds, the determination result is “Yes”, allowing the processing method 100 to proceed to the step of detecting postures 102. By contrast, when the preset object is not visible for the target duration of 15 seconds within the segment duration of 20 seconds, the determination result is “No”, allowing the processing method 100 to return to the step of identifying an object 101 (process flow A).

In process flow B illustrated in FIG. 5, the step of detecting postures 102 involves detecting, using artificial intelligence, the preset object's body transforming from a first posture to a second posture, determining whether the first posture is visible for a first posture duration within the target duration, and determining whether the second posture is visible for a second posture duration within the target duration. In an embodiment, the first posture duration meets a predetermined duration threshold equal to or greater than 4 seconds, and the second posture duration meets a predetermined duration threshold equal to or greater than 4 seconds. The step of detecting postures 102 further involves defining a body frame of the preset object and identifying a first confidence score for visibility of the first posture or the second posture.

In an embodiment, the processing method 100 proceeds to the step of detecting a human face 103 only when the time order for the first posture and the second posture within the segment duration is configured for the first posture to precede the second posture within the segment duration. Furthermore, the time order for the first posture and the second posture within the segment duration in an embodiment is from lying supine, lateral recumbent, lying prone, sitting, crawling, standing to embracing, or from lying prone, lateral recumbent, lying supine, sitting, crawling, or standing to embracing. The aforesaid time orders are typical of the development of body movements in the course of body growth in infancy, namely learning to sit, learning to crawl, learning to stand, learning to roll over, and begging for an embrace, but the present disclosure is not limited to the aforesaid time orders. Embodiments of capturing target postures related to a baby's learning to roll over, learning to sit, learning to crawl, learning to stand, learning to walk, and begging for an embrace are explained below.

Regarding how to perform the step of detecting a human face 103, process flow C illustrated in FIG. 6 involves detecting, using artificial intelligence, a human face being visible for a facial visibility duration within a target duration, and the capture requirement further includes the facial visibility duration reaching a duration threshold. In an embodiment, the step of detecting a human face 103 involves determining whether the facial visibility duration is equal to or greater than a predetermined duration threshold, say 10 seconds, allowing the processing method 100 to proceed to the step of capturing target postures 104 upon an affirmative determination but return to the step of identifying an object 101 (process flow A) upon a negative determination. The step of detecting a human face involves defining a face frame of the preset object and identifying a second confidence score for visibility of the face. Furthermore, the first posture duration, the second posture duration, and the facial visibility duration within the segment duration are each either continuous or intermittent and thus cumulative.

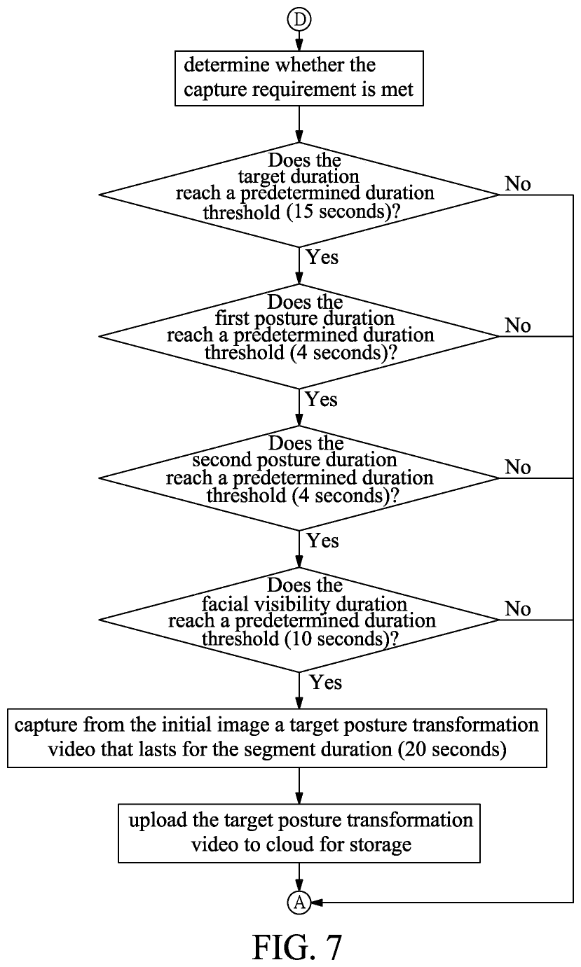

In process flow D illustrated in FIG. 7, the step of capturing target postures 104 involves capturing from the initial image V1 a target posture transformation video V2 which lasts for the segment duration of 20 seconds and uploading the target posture transformation video V2 to the cloud for storage when a capture requirement is met, wherein the capture requirement is met when the first posture duration and the second posture duration each reach a duration threshold within the target duration.

Specific embodiments of the present disclosure are exemplified by a preset object defined as a baby and described below.

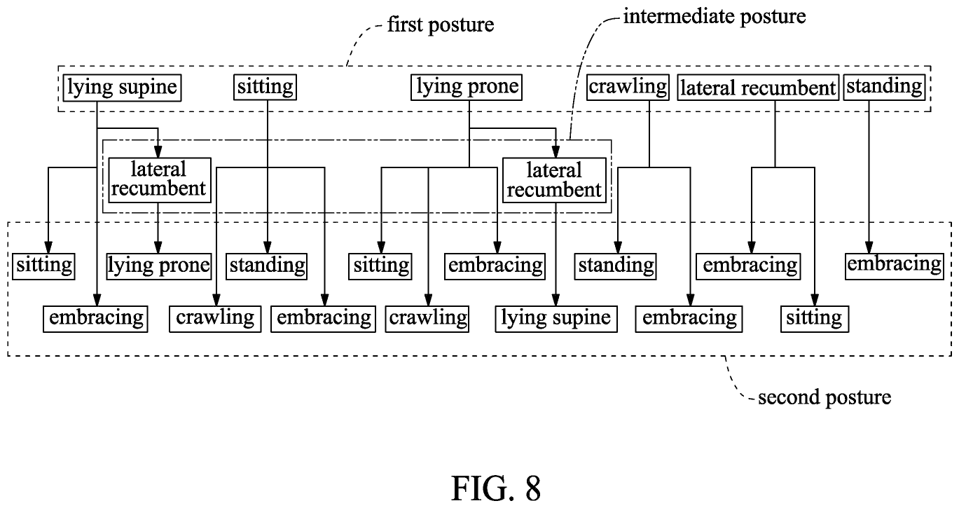

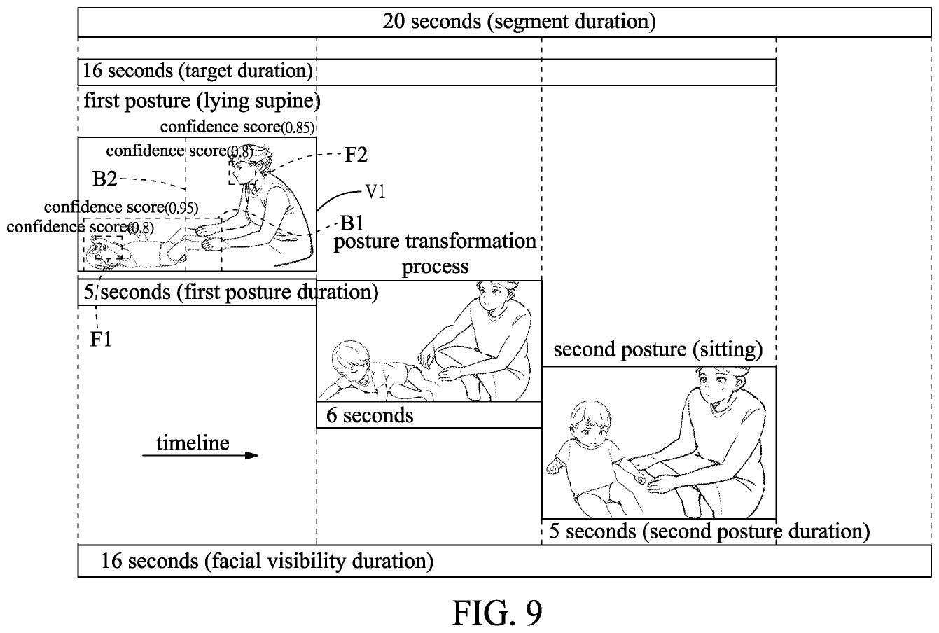

As shown in FIG. 9, a preset object is defined as a baby, and an instance of sitting in learning to sit is captured in the target posture transformation video V2 in an embodiment. As indicated by the time order depicted in FIG. 8, the first posture is one of lying supine, lying prone, and lateral recumbent, and the second posture is defined as sitting. Referring to FIG. 9, a preset object is a baby, and another object is an adult. In the step of the identifying an object 101, the electronic device 200 captures the baby's body frame B1 and face frame F1 from the initial image V1 in FIG. 9 and captures the adult's body frame B2 and face frame F2 from the initial image V1 in FIG. 9, and thus the initial image V1 comprises one preset object (baby) and another object (adult). Thus, as shown in process flow A illustrated in FIG. 4, upon an affirmative determination that the preset object in the initial image V1 is visible for a target duration (16 seconds in total) within a segment duration (for example, 20 seconds), the processing method 100 proceeds to the step of the detecting postures 102 (process flow B).

As indicated by the time order depicted in FIG. 9, the baby in the initial image V1 has a first posture (lying supine) and a second posture (sitting), and both the first posture duration and second posture duration are 5 seconds. The process flow B illustrated in FIG. 5 is followed by the step of detecting a human face 103 (process flow C) upon an affirmative determination that the first posture lasts for a first posture duration within the target duration (5 seconds) and then an affirmative determination that the second posture lasts for a second posture duration within the target duration (5 seconds), and the transformation process from the first posture to the second posture lasts for 6 seconds; thus, the baby's face is visible for a total of 16 seconds. The process flow C illustrated in FIG. 6 involves determining whether the facial visibility duration (within the target duration (15 seconds)) for which the face is visible is equal to or greater than a predetermined duration threshold (10 seconds), and the processing method 100 proceeds to the step of capturing target postures 104 (process flow D) when the determination is affirmative.

As shown in process flow D illustrated in FIG. 7, owing to the affirmative determination that the target duration (16 seconds) reaches a predetermined duration threshold (15 seconds), the affirmative determination that the first posture duration (5 seconds) reaches a predetermined duration threshold (4 seconds), the affirmative determination that the second posture duration (5 seconds) reaches a predetermined duration threshold (4 seconds), and the affirmative determination that the facial visibility duration (16 seconds) reaches a predetermined duration threshold (10 seconds), the capture requirement is met, such that the segment duration begins at the first second of the first posture duration and ends at the 20th second so as to capture a target posture transformation video V2 of an instance of learning to sit and upload the target posture transformation video V2 to the cloud for storage.

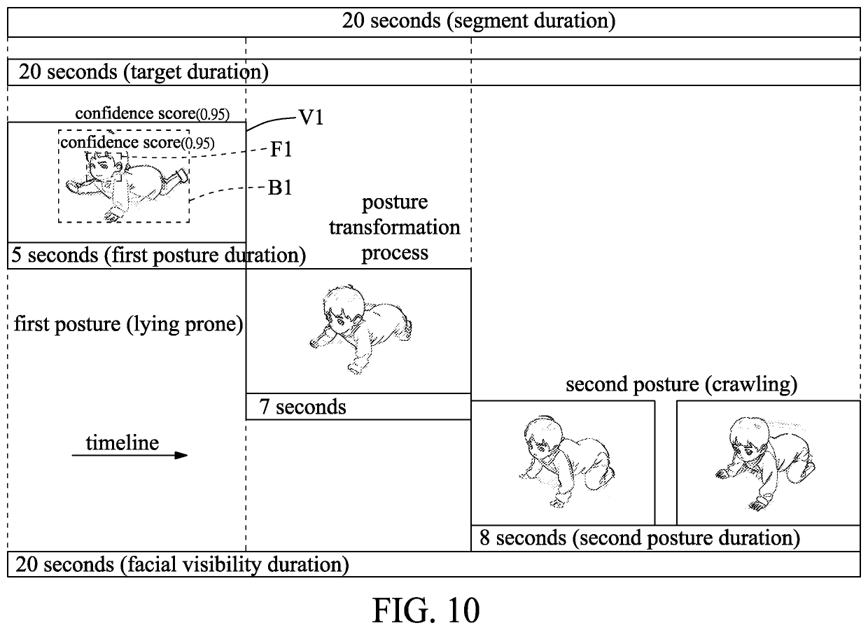

As shown in FIG. 10, a preset object is defined as a baby, and an instance of learning to crawl is captured in the target posture transformation video V2 in an embodiment. As indicated by the time order depicted in FIG. 8, the first posture is lying prone or lateral recumbent, and the second posture is crawling. As shown in FIG. 10, a preset object is defined as a baby, and in the step of identifying an object 101, the electronic device 200 captures the baby's body frame B1 and face frame F1 from the initial image V1 in FIG. 10, and the initial image V1 shows one preset object (baby). Thus, process flow A illustrated in FIG. 4 involves determining whether the preset object is visible for a target duration (a total of 20 seconds) within a segment duration (for example, 20 seconds) of the initial image V1, and the determination result is “Yes”, allowing the processing method 100 to proceed to the step of detecting postures 102 (process flow B).

As indicated by the time order depicted in FIG. 10, as shown in the initial image V1, the baby has a first posture, i.e., lying prone, and a second posture, i.e., crawling, the first posture duration lasts for 5 seconds, and the second posture duration lasts for 8 seconds. Thus, process flow B illustrated in FIG. 5, the determination result of determining whether the first posture lasts for a first posture duration within the target duration (5 seconds) is “Yes”, and the determination result of determining whether the second posture lasts for a second posture duration within the target duration (8 seconds) is also “Yes”, allowing the processing method 100 to proceed to the step of detecting a human face 103 (process flow C). It takes 7 seconds for the baby to transform from the first posture to the second posture, and its face is visible within the target duration of 20 seconds. In process flow C illustrated in FIG. 6, the facial visibility duration, i.e., the duration of the face being visible within the target duration (20 seconds), reaches a predetermined duration threshold (10 seconds), and thus the determination result is “Yes”, allowing the processing method 100 to proceed to the step of capturing target postures 104 (process flow D).

In process flow D illustrated in FIG. 7, the capture requirement is met because of the determination result “Yes” about whether the target duration (20 seconds) reaches a predetermined duration threshold (15 seconds), the determination result “Yes” about whether the first posture duration (5 seconds) reaches a predetermined duration threshold (4 seconds), the determination result “Yes” about whether the second posture duration (8 seconds) reaches a predetermined duration threshold (4 seconds), and the determination result “Yes” about whether the facial visibility duration (20 seconds) reaches a predetermined duration threshold (10 seconds). Thus, the segment duration in process flow D starts at the first second of the first posture duration and lasts for 20 seconds, rendering it feasible to capture a target posture transformation video V2 of an instance of learning to crawl and upload the target posture transformation video V2 to the cloud for storage.

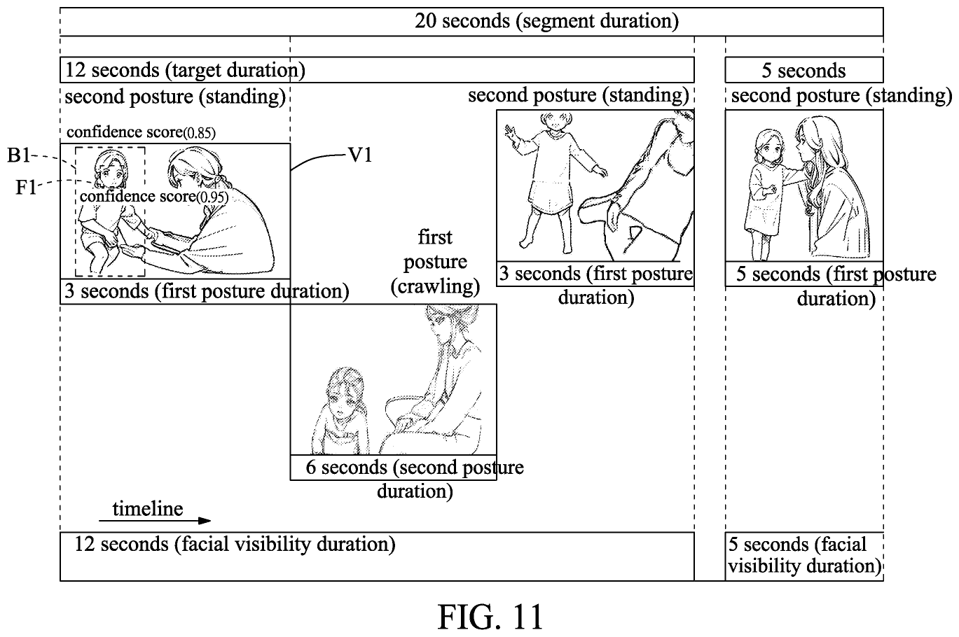

As shown in FIG. 11, a preset object is defined as a baby, and an instance of standing in learning to stand is captured in the target posture transformation video V2 in an embodiment. As indicated by the time order depicted in FIG. 8, the first posture is sitting or crawling, and the second posture is defined as standing. As shown in FIG. 11, a preset object is defined as a baby, and another object is defined as an adult. In the step of identifying an object 101, the electronic device 200 captures from the initial image V1 in FIG. 11 the baby's body frame B1 and face frame F1 as well as the adult's body frame B2 and face frame F2, and thus the initial image V1 shows one preset object (baby) and another object (adult). Therefore, in process flow A illustrated in FIG. 4, the determination result about whether the preset object is visible for a target duration (a total of 20 seconds) within a segment duration (for example, 20 seconds) of the initial image V1 is “Yes”, allowing the processing method 100 to proceed to the step of detecting postures 102 (process flow B).

As indicated by the time order depicted in FIG. 11, as shown in the initial image V1, the baby has a first posture, i.e., standing, and a second posture, i.e., crawling. The first posture duration is intermittent and adds up to 11 seconds. The second posture duration lasts for 6 seconds. Thus, in process flow B illustrated in FIG. 5, the determination result about whether the first posture lasts for a first posture duration within the target duration (adding up to 11 seconds) is “Yes”, and the determination result about whether the second posture lasts for a second posture duration within the target duration (6 seconds) is also “Yes”, allowing the processing method 100 to proceed to the step of detecting a human face 103 (process flow C). It takes 1 second for the baby to transform from the first posture to the second posture, and its face is visible for 17 seconds within the total duration of 20 seconds. In process flow C illustrated in FIG. 6, the determination result about whether the facial visibility duration, i.e., the duration of the face being visible within the target duration (17 seconds), reaches a predetermined duration threshold (10 seconds) is “Yes”, allowing the processing method 100 to proceed to the step of capturing target postures 104 (process flow D).

In process flow D illustrated in FIG. 7, the capture requirement is met because of the determination result “Yes” about whether the target duration (20 seconds) reaches a predetermined duration threshold (15 seconds), the determination result “Yes” about whether the first posture duration (11 seconds) reaches a predetermined duration threshold (4 seconds), the determination result “Yes” about whether the second posture duration (6 seconds) reaches a predetermined duration threshold (4 seconds), and the determination result “Yes” about whether the facial visibility duration (17 seconds) reaches a predetermined duration threshold (10 seconds). Thus, the segment duration in process flow D starts at the first second of the first posture duration and lasts for 20 seconds, rendering it feasible to capture a target posture transformation video V2 of an instance of learning to stand and upload the target posture transformation video V2 to the cloud for storage.

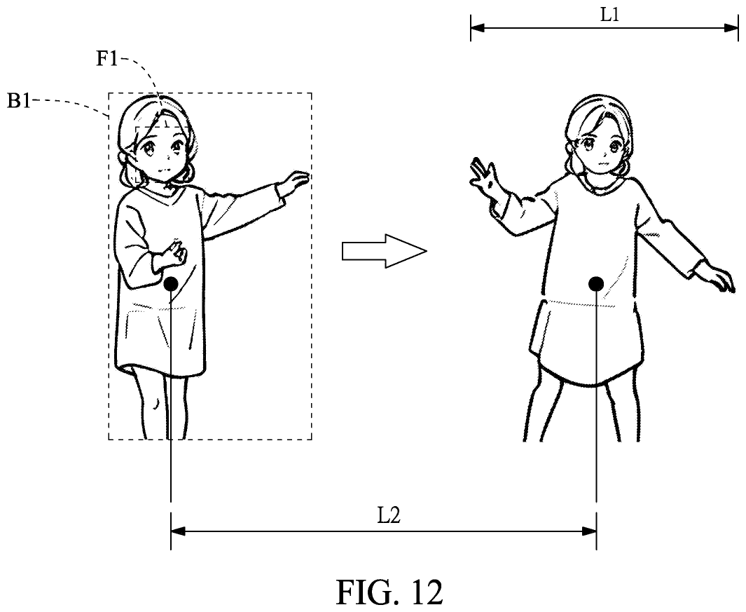

The instance of learning to stand is followed by an instance of learning to walk, and thus the second posture is defined as standing. Thus, as shown in FIG. 12, the body frame B1 of the standing preset object is defined, a body width L1 of the preset object is calculated according to the body frame B1, and a center Cl of the body frame B1 is defined. The step of detecting postures 102 involves detecting the standing preset object's movement and calculating a movement distance L2 of the coordinates of the center Cl after the preset object's body has transformed from the first posture, i.e., sitting, to the second posture, i.e., standing, within the target duration (20 seconds). In the step of capturing target postures 104, the capture requirement further includes the movement distance L2 being greater than the body width L1 so as to capture a target posture transformation video V2 of an instance of learning to walk and upload the target posture transformation video V2 to the cloud for storage.

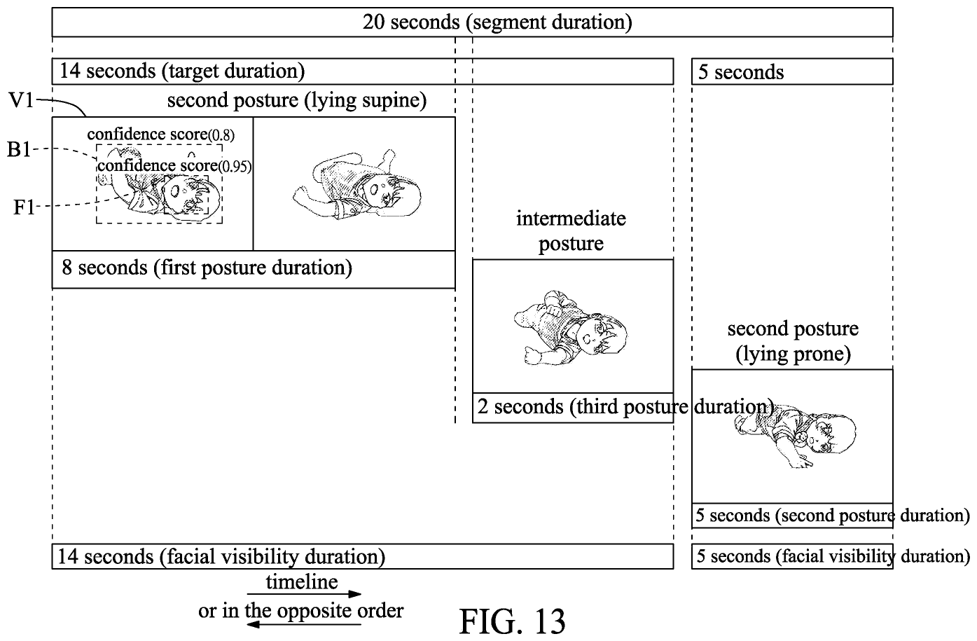

As shown in FIG. 13, a preset object is defined as a baby, and an instance of learning to roll over is captured in the target posture transformation video V2 in an embodiment. As indicated by the time order depicted in FIG. 8, the first posture is lying supine, and the second posture is lying prone. As shown in FIG. 13, a preset object is defined as a baby, and in the step of the identifying an object 101 the electronic device 200 captures from the initial image V1 in FIG. 13 the baby's body frame B1 and face frame F1, and thus the initial image V1 shows one preset object (baby). Therefore, in process flow A illustrated in FIG. 4, the determination result of determining whether the preset object is visible for a target duration (a total of 20 seconds) within a segment duration (for example, 20 seconds) in the initial image V1 is “Yes”, allowing the processing method 100 to proceed to the step of detecting postures 102 (process flow B).

As indicated by the time order depicted in FIG. 13, the baby in the initial image V1 has a first posture, i.e., lying supine, and a second posture, i.e., lying prone, the first posture duration lasts for 8 seconds, and the second posture duration lasts for 5 seconds. Thus, in process flow B illustrated in FIG. 5, the determination result of determining whether the first posture lasts for a first posture duration within the target duration (8 seconds) is “Yes”, and the determination result of determining whether the second posture lasts for a second posture duration within the target duration (5 seconds) is also “Yes”. In an embodiment, the capture requirement further includes an intermediate posture which is lateral recumbent. Thus, in the step of detecting postures 102, the capture requirement for capturing an instance of learning to roll over in this embodiment is met only when the intermediate posture is detected to be visible for a third posture duration (2 seconds) within the target duration and reach a duration threshold (1 second).

In the step of detecting a human face 103 (process flow C), it takes 8 seconds for the baby to transform from the first posture to the second posture, and out of the total of 20 seconds the facial visibility duration lasts for 19 seconds. In process flow C illustrated in FIG. 6, the determination result of determining whether the facial visibility duration, i.e., the duration of the face being visible within the target duration (19 seconds), reaches a predetermined duration threshold (10 seconds) is “Yes”, allowing the processing method 100 to proceed to the step of capturing target postures 104 (process flow D).

In process flow D illustrated in FIG. 7, the capture requirement is met because of the determination result “Yes” about whether the target duration (20 seconds) reaches a predetermined duration threshold (15 seconds), the determination result “Yes” about whether the first posture duration (5 seconds) reaches a predetermined duration threshold (4 seconds), the determination result “Yes” about whether the second posture duration (8 seconds) reaches a predetermined duration threshold (4 seconds), the determination result “Yes” about whether the third posture duration (2 seconds) reaches a predetermined duration threshold (1 second), and the determination result “Yes” about whether the facial visibility duration (20 seconds) reaches a predetermined duration threshold (10 seconds). Thus, the segment duration in process flow D starts at the first second of the first posture duration and lasts for 20 seconds, rendering it feasible to capture a target posture transformation video V2 of an instance of learning to roll over and upload the target posture transformation video V2 to the cloud for storage.

As shown in FIG. 14, a preset object is defined as a baby, and an instance of begging for an embrace is captured in a target posture transformation video V2 in an embodiment. As indicated by the time order depicted in FIG. 8, the first posture is one of lying supine, lateral recumbent, lying prone, and sitting, whereas the second posture is embracing, with the preset object begging the another object for an embrace on-site, or the preset object has the first posture being crawling or standing and the second posture being defined as embracing, with the preset object taking the initiative to approach the another object to beg for an embrace. As shown in FIG. 14, a preset object is defined as a baby, and another object is an adult. In the step of identifying an object 101, the electronic device 200 captures from the initial image V1 in FIG. 14 the baby's body frame B1 and face frame F1 as well as the adult's body frame B2 and face frame F2, and thus the initial image V1 shows one preset object (baby) and another object (adult). Therefore, as shown in process flow A illustrated in FIG. 4, the determination result about whether the preset object is visible for a target duration (a total of 20 seconds) within a segment duration (for example, 20 seconds) in the initial image V1 is “Yes”, allowing the processing method 100 to proceed to the step of detecting postures 102 (process flow B).

As indicated by the time order depicted in FIG. 14, in the initial image V1, the baby has a first posture, i.e., standing, and a second posture, i.e., embracing. The first posture duration is intermittent and adds up to 9 seconds. The second posture duration lasts for 8 seconds. Thus, in process flow B illustrated in FIG. 5, the determination result about whether the first posture lasts for a first posture duration within the target duration (adding up to 9 seconds) is “Yes”, and the determination result about whether the second posture lasts for a second posture duration within the target duration (8 seconds) is also “Yes”. In this embodiment, the processing method 100 skips the step of detecting a human face 103 (process flow C) and directly proceeds to the step of capturing target postures 104 (process flow D).

In process flow D illustrated in FIG. 7, the capture requirement is met because of the determination result “Yes” about whether the target duration (20 seconds) reaches a predetermined duration threshold (15 seconds), the determination result “Yes” about whether the first posture duration (9 seconds) reaches a predetermined duration threshold (4 seconds), and the determination result “Yes” about whether the second posture duration (8 seconds) reaches a predetermined duration threshold (4 seconds); thus, the segment duration in process flow D starts at the first second of the first posture duration and lasts for 20 seconds, rendering it feasible to capture a target posture transformation video V2 of an instance of embracing and upload the target posture transformation video V2 to the cloud for storage.

Therefore, the present disclosure has the following advantages. The processing method 100 for human body posture transformation and the electronic device 200, as provided by the present disclosure, are effective in automatically capturing a target posture transformation video V2 that lasts for a segment duration and uploading the target posture transformation video V2 to the cloud for storage and for subsequent download therefrom through the terminal device 300 for playing so as to meet user expectations. The capture requirement is met upon detection that the preset object's body transforms from a posture to another posture, with the two postures selected from two different ones of lying supine, lateral recumbent, lying prone, sitting, crawling, standing, and embracing respectively, and that each posture is visible for a posture duration which reaches a duration threshold. Thus, according to the present disclosure, the processing method 100 for human body posture transformation and the electronic device 200 not only analyze and process the initial image V1 using artificial intelligence but also enable the capture requirement to focus on the course of dynamic variations in limb movements, allowing the baby's body movements related to learning to roll over, learning to sit, learning to crawl, learning to stand, and learning to walk, for example, to be instantly, automatically, and precisely identified so as for images of the baby's body movements to be captured and processed to create the target posture transformation video V2 so as to optimize image processing and meet user expectations.

The present disclosure is disclosed above by preferred embodiments. However, persons skilled in the art should understand that the embodiments are illustrative of the present disclosure only, but shall not be interpreted as restrictive of the scope of the present disclosure. Thus, all equivalent modifications and replacements made to the aforesaid embodiments shall be deemed falling within the scope of the claims of the present disclosure. Accordingly, the legal protection for the present disclosure shall be defined by the appended claims.

What is claimed is:

1. An image processing method for human body posture transformation, the method being executed by an electronic device reading an executable code to identify a preset object using artificial intelligence, and performing image processing to capture target postures of the preset object, the method comprising the steps of:
identifying an object: identifying the preset object in an initial image using artificial intelligence, and detecting the preset object being visible in the initial image for a target duration within a segment duration;
detecting postures: detecting, using artificial intelligence, the preset object's body transforming from a first posture to a second posture, wherein the first posture and the second posture are two different postures of lying supine, lateral recumbent, lying prone, sitting, crawling, standing, and embracing, the first posture lasts for a first posture duration within the target duration, and the second posture lasts for a second posture duration within the target duration; and
capturing target postures: capturing from the initial image a target posture transformation video that lasts for the segment duration and uploading the target posture transformation video to cloud for storage when a capture requirement is met, wherein the capture requirement is met when the first posture duration and the second posture duration each reach a duration threshold within the target duration.

2. The image processing method for human body posture transformation according to claim 1, wherein a step of detecting a human face precedes the step of capturing target postures and entails detecting a human face being visible for a facial visibility duration within the target duration using artificial intelligence, and the capture requirement further includes the facial visibility duration reaching a duration threshold.

3. The image processing method for human body posture transformation according to claim 2, wherein, within the segment duration, the first posture precedes the second posture.

4. The image processing method for human body posture transformation according to claim 3, wherein a time order for the first posture and the second posture within the segment duration is from lying supine, lateral recumbent, lying prone, sitting, crawling, standing, to embracing, or from lying prone, lateral recumbent, lying supine, sitting, crawling, standing, to embracing.

5. The image processing method for human body posture transformation according to claim 4, wherein the preset object is defined as a baby, the second posture is defined as standing, and the image processing method further comprises defining a body frame of the standing preset object, calculating a body width of the preset object according to the body frame, defining a center of the body frame, and detecting the standing preset object's movement and calculating a movement distance of the center after the preset object's body has transformed from the first posture to the second posture within the target duration in the step of the detecting postures, wherein in the step of capturing target postures the capture requirement further includes the movement distance being greater than the body width.

6. The image processing method for human body posture transformation according to claim 4, wherein the preset object is defined as a baby, the first posture and the second posture are lying supine and lying prone respectively, the step of detecting postures further comprises detecting an intermediate posture while the preset object's body is transforming from the first posture to the second posture within the segment duration, and in the step of capturing target postures the capture requirement further includes the intermediate posture being lateral recumbent, the intermediate posture being visible for a third posture duration within the target duration, and the third posture duration reaching a duration threshold.

7. The image processing method for human body posture transformation according to claim 4, wherein another object other than the preset object can be identified in the step of identifying an object, the preset object's face and/or the another object's face are/is detected in the step of detecting a human face, and, in the step of detecting postures, the preset object has the first posture being one of lying supine, lateral recumbent, lying prone, sitting, crawling, and standing and the second posture being embracing, with the preset object begging the another object for an embrace on-site, or the preset object has the first posture being the crawling or standing and the second posture being embracing, with the preset object taking the initiative to approach the another object to beg for an embrace.

8. The image processing method for human body posture transformation according to claim 1, wherein the first posture duration, the second posture duration, and the facial visibility duration within the segment duration are each either continuous or intermittent and thus cumulative.

9. The image processing method for human body posture transformation according to claim 2, wherein the step of detecting postures further comprises defining a body frame of the preset object and identifying a first confidence score for visibility of the first posture or the second posture, and the step of detecting a human face further comprises defining a face frame of the preset object and identifying a second confidence score for visibility of the face.

10. A terminal device in communication connection with the electronic device for executing the method of claim 1, wherein the terminal device comes with an executable application, executes the application to connect to the cloud, and downloads the target posture transformation video for playing.

11. An electronic device for initial image processing, comprising:
a camera unit for taking an initial image;
an intelligent processing unit electrically connected to the camera unit to receive the initial image, comprising:
a target detection module for identifying a preset object in the initial image using artificial intelligence and detecting the preset object being visible in the initial image for a target duration within a segment duration;
a posture identification module electrically connected to the target detection module to detect, using artificial intelligence, the preset object's body transforming from a first posture to a second posture, wherein the first posture and the second posture are two different postures of lying supine, lateral recumbent, lying prone, sitting, crawling, standing, and embracing, the first posture lasts for a first posture duration within the target duration, and the second posture lasts for a second posture duration within the target duration; and
a target posture capturing module electrically connected to the target detection module and the posture identification module, the target posture capturing module setting a duration threshold for each of the target duration, the first posture duration and the second posture duration, wherein a capture requirement is met when the first posture duration and the second posture duration reach the duration thresholds respectively, causing the target posture capturing module to capture from the initial image a target posture transformation video that lasts for the segment duration and upload the target posture transformation video to cloud for storage.

12. The electronic device for initial image processing according to claim 11, wherein the camera unit and the intelligent processing unit are each a physical host.

13. The electronic device for initial image processing according to claim 11, wherein the intelligent processing unit further comprises a human face identification module adapted to detect, using artificial intelligence, a human face being visible for a facial visibility duration within the target duration, the target posture capturing module sets a duration threshold for the facial visibility duration, and the capture requirement further includes the facial visibility duration reaching the duration threshold.

14. A terminal device in communication connection with the electronic device of claim 11, wherein the terminal device comes with an executable application, executes the application to connect to the cloud, and downloads the target posture transformation video for playing.

15. A non-transient computer-readable recording medium, for storing a plurality of executable codes, the executable codes being read by an electronic device to allow the electronic device to identify a preset object using artificial intelligence and perform image processing to capture target postures of the preset object in the steps of:
identifying an object: identifying the preset object in an initial image using artificial intelligence and detecting a target duration for which the preset object in the initial image is visible within a segment duration;
detecting postures: detecting, using artificial intelligence, the preset object's body transforming from a first posture to a second posture, wherein the first posture and the second posture are two different postures of lying supine, lateral recumbent, lying prone, sitting, crawling, standing, and embracing, the first posture lasts for a first posture duration within the target duration, and the second posture lasts for a second posture duration within the target duration; and
capturing target postures: capturing from the initial image a target posture transformation video that lasts for the segment duration and uploading the target posture transformation video to cloud for storage when a capture requirement is met, wherein the capture requirement is met when the first posture duration and the second posture duration each reach a duration threshold within the target duration.
